(19) United States
(12) Patent Application Publication
(10) Pub. No.: US 2020/0267958 A1
(43) Pub. Date: Aug. 27, 2020

(54) Fish Attractants and Chum Systems

(71) Applicants: Gregory J. Mitchell, Norwich, CT (US); Mark B. Williams, Half Moon Bay, CA (US)

(72) Inventors: Gregory J. Mitchell, Norwich, CT (US); Mark B. Williams, Half Moon Bay, CA (US)

(21) Appl. No.: 16/815,174

(22) Filed: Mar. 11, 2020

Related U.S. Application Data
(63) Continuation-in-part of application No. PCT/US19/15323, filed on Jan. 28, 2019.
(60) Provisional application No. 62/816,405, filed on Mar. 11, 2019.

(51) Int. Cl. A01K 97/04; A23K 50/80

(52) U.S. Cl. CPC A01K 97/045; A23K 50/80

(57) ABSTRACT

Fish attractants comprising one or more liver derivative compounds, e.g., water-extract of dried beef liver or a bile salt, and one or more amino acids selected from the group consisting of alanine, arginine, leucine, lysine, methionine, phenylalanine, proline and taurine. nucleosides, fish oils, are useful as water solutions or in dried form. Water solutions can be dispensed from drip bags onto a water surface to attract fish to the vicinity of the drip bag. for fishing aids in drip bag application, as solids for tea bag applications or as chum blocks. Solutions of fish attractant can be dried to a powder or combined in a solid form that can be dissolved or dispersed when presented in fishing waters.

### PRIORITY CLAIMS AND RELATED APPLICATIONS

This application claims priority to U.S. Provisional Patent Application No. 62/816,405, filed Mar. 11, 2019, disclosure of which is incorporated herein by reference in its entirety and to International Application No. PCT/US2019/015323, filed Jan. 28, 2019, the disclosure and claims of which are incorporated herein by reference in its entirety.

### FIELD OF THE INVENTION

Aspects of this invention relate to fish attractants having applications in sport fishing and aquaculture including fish attractant compositions comprising liver compounds, amino acids and/or nucleosides and other natural materials such as liver derivatives in a form for use as drip attractants, chum, aquaculture feed, baits and lures utilizing such fish attractant compositions and methods of making and using such drip attractants, chum, aquaculture feed, baits and lures.

### BACKGROUND OF THE INVENTION

Particular aspects of the inventions disclosed and claimed herein relate to fish attractants and their use in drip and chum systems. Chum is a traditional fish attractant that has evolved from fish parts, e.g., heads, organs, bones, skin, blood and/or oils, and sometimes includes additives likes proteins, peptides, amino acids. For example, one chum product is stated to contain seventeen amino acids; see Chumslick product from Aquatic Nutrition, Inc. Chum can be in various physical states including liquid, free mix of solids and liquids or dispersible solid. Chum is sometimes freely scattered on or below the surface of water; alternatively chum is dispersed from a container. See, for example, US Patent Application Publication US20150359226A1 disclosing synthetic bait pellets that can be made to be slow or fast dissolving depending on the application for attracting fish or crustaceans, e.g., crabs or lobster, to traps.

### SUMMARY OF THE INVENTION

Disclosed herein are fish attractants and chum systems for dispensing said fish attractants where the attractants comprise liver-derivative compounds and water soluble amino acids. Liver-derivative compounds can comprise water-extracted liver compounds, e.g, from dried liver powder, or bile salts. Amino acid-complexed bile salts can provide a source of amino acids, e.g., taurine and glycine, and serve as a detergent to solubilize fish oils attractants.

The fish attractants can be provided and used in chum systems in a dry or semi-dry state, e.g., as water soluble or water dispersible gels or powders or as compression-formed solids such as pellets, briquettes or blocks. In one embodiment of a dry chum system powdered fish attractant can be provided in water permeable bags, generally referred to as “tea bags”. Such tea bags containing a fish attractant can be tethered in a fishing location to function as chum. Solid fish attractants can be used in artificial baits adapted for dispensing attractants or in chum dispensers known in the art.

The fish attractants can also be provided and used in chum systems in liquid form, e.g., dissolved or dispersed in a water medium. In one embodiment of a liquid chum system the fish attractants can be provided in drip bags suspended over the water to provide a relatively long and continuous local application of the fish attractants.

### DETAILED DESCRIPTION

As used herein “solid state” means the physical condition of a material in which the material does not readily flow in the manner of water, e.g., turbid river water. A fish attractant in a solid state can be a dry powder, a compressed powder like a pellet, briquette or block, or a thickened moist composition like a dough, gel, pudding, honey or a thixotropic liquid composition.

As used herein “fluid state” means the physical condition of a material that readily flows with low viscosity, e.g., less than about 1000 centipoise at room temperature, such as in drops passing through a small orifice, e.g., less than about 2 millimeters in diameter. Such fluid state does not preclude the presence of small, dispersed particulate solids which can flow through such a drop-forming orifice. Emulsifiers and surfactants are useful for maintaining a fluid state when the fish attractant contains fine solids and hydrophobic ingredients such as oil.

As used herein “drip” refers to drops and fine streams, including a stream that transitions into droplets. An orifice for dispensing drops of liquid fish attractant can have a diameter of at least about 25 microns (micrometers). Higher flow of drops or a fine stream can be advantageously provided with larger diameters, e.g., in the range of about 200 to 500 microns, or up to 700 or 800 microns. A fine stream flow can be achieved by allowing the fish attractant to pass through a “capillary tube”, e.g., tubing with an internal diameter of about 2 mm.

As used herein “drip bag” means any liquid tight bag having a drip mechanism. Drip mechanisms can include (a) a section of a bag with porosity such as one or more small holes that can be uncovered or unsealed when put into use to effect drops or a fine stream, (b) a small diameter nozzle that can be uncapped to allow drops or a fine stream, (c) variable outlet valve regulating effluent, (d) a small diameter hose, e.g. a capillary hose, and other flow controls as would be well known and obvious to a person of ordinary skill in the art. Drip bags that are useful in the practice of this invention are available from Delco Products, LLC., which can be contacted through its “delcoproducts” website. Useful drip bags are disclosed in US Patent Application Publication 2018/0064095 A1 (Delehanty, et al.), incorporated herein by reference. An alternative drip bag design and methods for design of drip bags are disclosed in U.S. Pat. No. 9,675,062 B1 (Kuhn et al.), incorporated herein by reference, which discloses a bag with a drain diameter of 0.02 inches (500 microns).

Semi-dry and compressed solid fish attractant can be formed around a line or dispersed from porous bags or rigid containers with porosity that allows moving water to dissolve and carry away the fish attractant over of wide expanse of water. Dry powder fish attractant can be dispersed from small porosity bags such as tea bags that can retain the powder while allowing dissolved attractant to seep out and disperse. Tea bags and filter fabric for such tea bags can be provided from any of a number of dealers in commodity filter bags. Many users of chum according to this invention will prefer to use biodegradable bags such as bags made from porous nonwoven polylactic acid (PLA) available form One Earth, a NonWoven Network Company (see nonwovennetwork[dot]com). Alternative useful chum dispensers are disclosed in U.S. Pat. Nos. 2,844,907, 2,906,055, 4,903,429, 5,054,230, 6,955,006, 7,520,086 and US Patent Application Publication US20150359226A1, all of which are incorporated herein by reference.

The liver-derivative compounds useful in the fish attractants of the invention can be prepared from commercially available liver powders which are commonly available from poultry, e.g. chicken liver powder and turkey liver powder, bovine, e.g., beef liver powder and bison liver powder, and swine, e.g., pig liver powder. An advantageously available and relatively inexpensive liver powder is dried beef liver powder, including dried and defatted beef liver powder. Liver powder soluble components can be readily extracted with water in a number of known operations using heated water for effective extraction of soluble components. For example, liver powder can be mixed with heated water where the soluble extract is separated from undissolved solids, e.g., by percolation through a bed of retained solids, by mixing and separation or a combination of steps such as settling, decantation, filtration, centrifugation and the like. In one embodiment of the invention the fish attractant comprises water extracted liver compounds that are essentially free of solids, fats and water-insoluble liver compounds.

Other liver-derived compounds useful in fish attractants of the invention include bile acids, such as cholic acid, chenodeoxycholic acid and amino acid derivatives with an amino acid ligand such as taurine and glycine. Useful bile salts are sodium salts of steroid acids such as cholic acid, glycocholic acid, taurocholic acid, chenodeoxycholic acid, taurochenodeoxycholic acid and glycochenodeoxycholic acid. Bile acid salts are amphipathic and as such are able to serve as detergents to solublilize fats, e.g., fish oils, that may be used as a fish attractant.

When liver-derivative compounds are liver powder, amino acids, preservatives, and/or olfactory compounds such as nucleosides can be added to the extract at any convenient step during or after completion of the water extraction of the liver powder.

As used herein an “amino acid” means any of alanine, arginine, asparagine, aspartic acid, carnitine, cysteine, glutamic acid, glutamine, glycine, glycine betaine, histidine, hydroxyproline, isoleucine, leucine, lysine, methionine, norleucine, norvalene, phenylalanine, proline, sarcosine, serine, taurine, threonine, tryptophan, tyrosine, and valine. Amino acids, except for glycine, have an asymmetric carbon atom and can form optically active stereoisomers that are non-superimposable on each other. The biologically derived amino acid commonly distinguished from other isomers by the L-convention, e.g., L-valene. Although the L-amino acids are common, there is no known reason why other isomers will not be effective in the practice of this invention. For instance, U.S. Pat. No. 5,720,996 reports salmonid response to both L-proline and D-proline.

In embodiments of the invention the amino acid can be a single amino acid selected from the group consisting of alanine, arginine, betaine, leucine, methionine, phenylalanine, proline, serine, and taurine. In one embodiment of the invention at least 70%, in other cases at least 80%, even at least 90%, of the amino acids content of the fish attractant comprises one or more amino acids selected from the group consisting of alanine, arginine, leucine, methionine, phenylalanine, proline and taurine. In another embodiment of the invention at least 90% of the amino acids content of the fish attractant comprises at least three amino acids selected from the group consisting of alanine, arginine, leucine, methionine, phenylalanine and proline. In other embodiments of the invention the amino acid can consist of at least two amino acids selected from the group consisting of alanine, arginine, betaine, glycine, methionine, proline, serine and taurine. Embodiments of the invention include for instance, (a) arginine and methionine, (b) arginine and phenylalanine, (c) arginine and serine, (d) arginine and proline, (e) arginine and alanine, (f) alanine and proline, (g) methionine and taurine, (h) methionine and betaine, (i) methionine and proline, (j) methionine and serine, (k) methionine and phenylalanine, (I) betaine and proline, (m) taurine and alanine, (n) taurine and arginine, and (o) taurine and proline. In other embodiments of the invention the amino acids can be at least three amino acids, for instance, (a) alanine, arginine and proline, (b) betaine, proline and methionine, (c) arginine, methionine and proline, (d) arginine, phenylalanine and serine, (e) methionine, phenylalanine and proline, (f) methionine, proline and taurine and (g) alanine, methionine and proline. In other embodiments of the invention, the amino acids can comprise at least four amino acids, for instance, consisting of (a) alanine, arginine, methionine and proline, (b) arginine, methionine, phenylalanine and serine, (c) alanine, arginine, methionine and serine, (d) arginine, methionine, proline and taurine, and (e) betaine, methionine, proline and taurine. In other embodiments of the invention the amino acids can comprise at least five amino acids, for instance, (a) alanine, arginine, methionine, proline and taurine, (b) alanine, arginine, methionine, phenylalanine and serine, (c) arginine, betaine, methionine, phenylalanine and taurine, and (d) arginine, methionine, phenylalanine, proline and serine.

In other embodiments of the invention the amino acids can comprise at least six amino acids, for instance, (a) alanine, betaine, glycine, leucine, proline, and phenylalanine or (b) alanine, aspartic acid, betaine, glutamic acid, glycine, and taurine. In other embodiments of the invention the amino acids can comprise at least ten amino acids, for instance, alanine, arginine, betaine, glycine, leucine, methionine, phenylalanine, proline, taurine and tryptophan.

The amount of amino acids to liver extract is not critical. Useful fish attractants will have a weight ratio of amino acids to original liver powder of at least 2:1 or higher, say at least 3:1, 4:1.5:1 or higher even up to about 7:1 or 10:1.

A useful preservative for the fish attractant can be sodium benzoate, sodium propionate, or sodium sorbate, or other cationic salt hereof, which are commonly used antifungal preservatives. Other preservatives include ethanol, methanol and iodine. The amount of preservative used provides a weight ratio of starting liver powder to preservative of at least 10:1 or higher say at least 15:1 or even at least 20:1.

Olfactory compounds can be selected from trimethylamine, trimethylamine oxide, spermine, cadaverine, bile salts, vegetable oils, animal oils such as fish oils, nucleosides and nucleotides. As bile salts may tend to plug pinhole-sized orifices used in drip bags, the use of bile salts may be more amenable to chum applications. While bile salts have low water solubility, they are amphipathic (having surfactant properties) which aids in dispersing oil components. In some embodiments of the invention the fish attractant comprises bile salts and oils. When bile salts and oils are used in liquid fish attractants to be dispensed by drip bags, additional surfactants or emulsifiers, e.g., lecithin, lauric arginate and polyethoxylate sorbitan, can be used to keep fine particles and oils suspended in an aqueous medium of fish attractant. Other useful compounds for certain fish species include 4-aminobutylguanidine, alpha-amino butyric acid, alphaamino propionic acid, monosodium glutamate, homocysteine and alpha-amino guanidinopropionic acid.

Nucleosides include any of adenosine, cytidine, guanosine, inosine, thymidine, uridine and 5-methyluridine and deoxyribose-based nucleoside derivatives including deoxyadenosine, deoxyguanosine, deoxythymidine, deoxyuridine, and deoxycytidine. Nucleoside derivatives also include the corresponding nucleotides which are phosphate derivatives of nucleosides. Such nucleotides include adenosine monophosphate (AMP), adenosine diphosphate (ADP), adenosine triphosphate (ATP), guanosine monophosphate (CMP), guanosine diphosphate (GDP), guanosine triphosphate (GTP), cytidine monophosphate (CMP), cytidine diphosphate (CDP), cytidine triphosphate (CTP), inosine monophosphate (MP), inosine diphosphate (IDP), inosine triphosphate (ITP), thymidine monophosphate (TMP), thymidine diphosphate (TDP), thymidine triphosphate (TTP), uridine monophosate phosphate (UMP), uridine diphosphate (UDP) and uridine triphosphate (UTP). In certain aspects of the invention useful embodiments of the invention employ adenosine, uridine and/or cytidine and/or corresponding nucleotides.

The liquid comprising the water extract of liver powder, the amino acids and other compounds can be used in the concentrations as it is produced; alternatively, the liquid can be concentrated or diluted. Furthermore, to provide agglomerated fish attractant for use as chum the liquid can be dewatered to at least a degree of dehydration that provides a moist agglomerated mass. Extended dewatering can provide the fish attractant in dry powder form for the dry chum systems. Operations for drying liquids to powders are well know in the art and can include evaporation, e.g. vacuum assisted evaporation, and freeze drying (also known as lyophilization). Alternatively, for producing a solid chum liver powder can be used in its original dry state without the need for making a water extract. It may be advantageous to provide thickener such as starch, vegetable gum like galactan gum if a moist dough-like chum product is desired.

The following examples illustrates methods of preparing and using fish attractants.

### Example 1

This example illustrates a method for preparing an aqueous fish attractant solution suitable for dispensing from a drip bag. A liquid fish attractant was prepared using a large (nominal 100 cup) percolating coffee maker filled with 3 gallons of water. Four cups (960 cc) of dried beef liver powder and 1 tablespoon (15 cc) of sodium benzoate were placed in a percolation basket of the coffee maker. The weight ratio of starting liver powder to preservative was about 15:1. Hot water extraction by percolation was maintained until the rate of solubilization of liver powder was diminished leaving in the basket essentially insoluble matter from the liver powder. The insoluble matter was removed and amino acids comprising 2 cups (480 cc) of glycine, and one and one-eighth cup (270 cc) each of L-methionine and L-proline were added to the percolation basket. The weight ratio of amino acids to original beef liver powder was 2.7:1. Heated liver extract solution was percolated through the basket to dissolve the amino acids. The liquid was allowed to cool in the coffee maker to allow solids to settle from the solution providing a fish attractant solution comprising water-extracted liver compounds and amino acids.

### Example 2

This example illustrates a method of using a fish attractant solution by dispensing from a drip bag. A 3 ounce (90 cc) volume of the fish attractant solution prepared in Example 1 was transferred into a sealable plastic bag having a drip valve. The sealed bag was suspended over lake water from a fishing boat, the drip valve was opened allowing the fish attractant solution to drip into the lake water in the vicinity of the boat. As the fish attractant was being dispersed in the water, the rate of fish being caught increased.

### Example 3

This example illustrates the preparation and use of fish attractant solutions comprising nucleoside compounds. Seven separate liquid fish attractant samples prepared as in Example 1 are supplemented by addition of one-half cup (120 cc) of one of the following nucleosides: adenosine, cytidine, guanosine, inosine, thymidine, uridine and 5-methyluridine. The nucleoside-supplemented fish attractants are dispensed drop-wise from drip bags into lake water to attract fish following the method of Example 2.

### Example 4

This example illustrates the preparation and use of fish attractant solutions comprising nucleotide compounds. The procedures of example 1 are replicated to prepare 18 separate solutions of fish attractant except that each solution is supplemented with one-half cup (120 cc) of one of the following nucleotide compounds: adenosine monophosphate (AMP), adenosine diphosphate (ADP), adenosine triphosphate (ATP), guanosine monophosphate (GMP), guanosine diphosphate (GDP), guanosine triphosphate (GTP), cytidine monophosphate (CMP), cytidine diphosphate (CDP), cytidine triphosphate (CTP), inosine monophosphate (IMP), inosine diphosphate (IDP), inosine triphosphate (ITP), thymidine monophosphate (TMP), thymidine diphosphate (TDP), thymidine triphosphate (TTP), uridine monophosphate (UMP), uridine diphosphate (UDP) and uridine triphosphate (UTP). The nucleoside-supplemented fish attractants are dispensed drop-wise from drip bags into lake water to attract fish.

### Example 5

This example illustrates the preparation and use of a fish attractant solution comprising beef liver extract, four amino acids and a nucleoside. The procedure of example 1 was repeated except that the amino acids were replaced with 2 cups (480 cc) of the amino acid proline, 1 cup (240 cc) each of the amino acids alanine, arginine, methionine and 1 cup (240 cc) of the nucleoside adenosine. The fish attractant is dispensed drop-wise from a drip bags into lake water to attract fish.

### Example 6

This example illustrates the preparation of a fish attractant following the procedure of Example 5 with the further addition of 1 cup (240 cc) of the amino acid taurine. The fish attractant is dispensed drop-wise from a drip bags into sea water to attract fish.

### Example 7

This example illustrates the preparation of a fish attractant following the procedure of Example 1 except that the amino acids were replaced with 2 and one-half cups (600 cc) of tryptophan, 1 cup (240 cc) each of isoleucine and glutamic acid. The fish attractant is dispensed drop-wise from a drip bags into lake water to attract fish.

### Example 8

This example illustrates the preparation of a fish attractant following the procedure of Example 1 except that the amino acids were replaced with 2 cups (480 cc) of cysteine, 1 cup (240 cc) each of lysine and valine, one-half cup (120 cc) of tyrosine and one-quarter cup (60 cc) each of glycine and asparagine. The fish attractant is dispensed drop-wise from a drip bags into lake water to attract fish.

### Example 9

This example illustrates the preparation of a fish attractant following the procedure of Example 1 except that the amino acids were replaced with 2 cups (480 cc) of glycine betaine, 1 cup (240 cc) each of phenylalanine, serine, tryptophan and valine. The fish attractant is dispensed drop-wise from a drip bags into lake water to attract fish.

### Example 10

This example illustrates the preparation of a fish attractant following the procedure of Example 1 except that the amino acids were replaced with 3 cups (720 cc) of serine, 2 cups (480 cc) of histidine, and one-half cup (120 cc) each of asparagine, tyrosine and valine. The fish attractant is dispensed drop-wise from a drip bags into lake water to attract fish.

### Example 11

This example illustrates the preparation of a fish attractant following the procedure of Example 1 except that the amino acids were replaced with 3 cups (720 cc) of histidine and one and one-half cups (360 cc) of glutamic acid. The fish attractant is dispensed drop-wise from a drip bags into lake water to attract fish.

### Example 12

This example illustrates the preparation of a fish attractant in the form of a solid biscuit that tends to sink in water. Whole wheat flour (89 part), menhaden oil (5 parts), glycocholic acid sodium salt (1 part), fish attractant according to example 1 (5 parts) and sodium benzoate (1 part) are mixed to forma dough which is molded into biscuits and baked at 250 degrees Fahrenheit until the biscuit is dry. A biscuit is tied to the end of a fishing boat in water to attract fish to the area of the boat. Fish attractant emanating from the biscuit attract fish which are caught on conventional bait.

### Example 13

This example illustrates the preparation of a fish attractant in the form of a solid biscuit that tends to float in water that is produced according to the procedure of example 12 with the addition of 5 parts of baking powder and 5 parts bread yeast. The mixture is allowed to rest and rise before baking to produce expanded bread like biscuits that tends to float for a while before becoming water logged.

While the present invention has been described with reference to the specific embodiments thereof, it should be understood by those skilled in the art that various changes may be made and equivalents may be substituted without departing from the true spirit and scope of the invention. In addition, many modifications may be made to adapt to a particular situation, material, composition of matter, process step or steps, to the objective, spirit and scope of the present invention. All such modifications are intended to be within the scope of claims appended hereto.

What is claimed is:

1. A fish attractant device comprising a drip bag for dispersing a stream or droplets and a liquid fish attractant solution contained therein, wherein said liquid fish attractant solution is an aqueous solution comprising liver compounds and at least one amino acid, wherein said liver compounds are selected from water-extracted liver powder and bile salts, and said at least one amino acid is selected from the group consisting of alanine, arginine, leucine, lysine, methionine, phenylalanine, proline and taurine.

2. A fish attractant device comprising a solid, water-dispersible mixture comprising an liver compounds and at least one amino acid, wherein said liver compounds are selected from water-extracted liver powder and bile salts, and said at least one amino acid is selected from the group consisting of alanine, arginine, leucine, lysine, methionine, phenylalanine, proline and taurine.

3. A fish attractant device of claim 2 wherein said solid, water-dispersible mixture is in powder form within a water permeable bag.

4. A fish attractant comprising liver compounds and at least one amino acid, wherein said liver compounds are selected from water-extracted liver powder and bile salts, and said at least one amino acid is selected from the group consisting of alanine, arginine, leucine, lysine, methionine, phenylalanine, proline and taurine; and wherein at least 90% of the amino acid content of said fish attractant comprises amino acids selected from the group consisting or alanine, arginine, leucine, lysine, methionine, phenylalanine, proline and taurine.

5. The fish attractant of claim 4 wherein the liver powder is dried bovine liver powder.

6. The fish attractant of claim 4 further comprising at least one nucleoside is selected from the group consisting of adenosine, cytidine, guanosine, inosine, thymidine, uridine, 5-methyluridine and phosphates thereof.

7. The fish attractant of claim 4 wherein the weight ratio of amino acid and nucleoside to liver compounds is at least 2:1.

8. The fish attractant of claim 4 wherein the water extracted liver compounds are essentially free of solids, fats and water-insoluble liver compounds.

9. The fish attractant of claim 4 further comprising a preservative compound in weight ratio of liver powder to preservative compound of at least 10:1.

10. The fish attractant of claim 9 wherein the preservative compound is sodium benzoate.

11. The fish attractant of claim 4 further comprising bile salt and an oil.

12. The fish attractant of claim 11 wherein the bile salt is selected from cholic acid, glycocholic acid, taurocholic acid, chenodeoxycholic acid, taurochenodeoxycholic acid and glycochenodeoxycholic acid, and wherein the oil is a fish oil.

13. The fish attractant of claim 4 wherein the components are in a solid state that is water soluble or water dispersible.

14. The fish attractant of claim 4 wherein the components are in a fluid state dissolved or dispersed in an aqueous medium.

15. The fish attractant of claim 13 wherein at least 70% of the amino acid content of said fish attractant comprises amino acids selected from the group consisting or alanine, arginine, leucine, lysine, methionine, phenylalanine, proline and taurine.

16. The fish attractant of claim 13 wherein at least 70% of the amino acid content of said fish attractant comprises amino acids selected from the group consisting or alanine, arginine, leucine, lysine, methionine, phenylalanine, proline and taurine.
